(19) United States
(12) Patent Application Publication
(10) Pub. No.: US 2020/0145628 A1
(43) Pub. Date: May 7, 2020

(54) PROJECTION APPARATUS AND CORRECTING METHOD OF DISPLAY IMAGE

(71) Applicant: Coretronic Corporation, Hsin-Chu (TW)

(72) Inventors: Chun-Lin Chien, Hsin-Chu (TW); Yu-Kuan Chang, Hsin-Chu (TW); Yung-Chiao Liu, Hsin-Chu (TW)

(73) Assignee: Coretronic Corporation, Hsin-Chu (TW)

(21) Appl. No.: 16/180,024

(22) Filed: Nov. 5, 2018

(51) Int. Cl. H04N 9/31; G03B 21/14

(52) U.S. Cl. CPC H04N 9/3185; H04N 9/3188; G03B 21/147

(57) ABSTRACT

A projection apparatus and a correcting method of a display image are provided. Positions of identification points and an original point are determined, where the positions of the identification points relate to a size of the display image. An indication line is generated according to a selected identification point of the identification points and the original point. A correcting graphic content on the display image, which includes the identification points, the original point and the indication line, is displayed. A control signal, which indicates a movement of the selected identification point, is received. The position of the selected identification point and the indication line according to the control signal are modified, to modify the size of the display image.

### BACKGROUND OF THE DISCLOSURE

### 1. Field of the Disclosure

The present disclosure generally relates to an image projection technology, in particular, to a projection apparatus and a correcting method of a display image.

### 2. Description of Related Art

People may use a projector to watch movies, watch sports, or present lecture slides, so as to display a larger image on a screen. In usual, after a projector is placed at a desired position and the projector is powered on, the projector can start to display a display image (i.e., a projected image). The display image projected by the projector may not fit the size of a project target (such as a projection screen, a white board, a wall, or other desired object) on where the display image is displayed at first. Without moving the projector, the projector provides a warp function to warp the display image, so that the size or the shape of the display image could be fitted with the size or the shape of the project target. However, in some circumstances, the size of the display image may be larger than the project target, so that a modified point for the warp function on the display image may not be easy to be identified. It is hard for user to wrap the display image, and the user may take much time on the warping procedure.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure were acknowledged by a person of ordinary skill in the art.

### SUMMARY OF THE DISCLOSURE

Accordingly, the present disclosure is directed to a projection apparatus and a correcting method of a display image, to provide an easy and convenient way to modify the size of the display image.

Other objective and advantages of the present disclosure may be further understood from the technical features disclosed herein.

In order to achieve one, a portion or all of the above or other objectives, in accordance with an embodiment of the present disclosure, the projection apparatus includes an input device, a memory, a projection module and a processor. The input device receives a control signal. The memory stores a correcting graphic content. The correcting graphic content includes identification points, an original point and an indication line. The indication line relates to a connection between the original point and a selected identification point of the identification points. The projection module is coupled to the memory and displays the correcting graphic content on a display image. The processor is coupled to the input device, the memory and the projection module. The processor controls the projection module to display the display image. The processor is configured to perform the following steps.

In order to achieve one, a portion or all of the above or other objectives, in accordance with an embodiment of the present disclosure, the correcting method of a display image is adapted for a projection apparatus, which displays the display image. The correcting method includes the following steps. Positions of identification points and a position of an original point are determined, where the positions of the identification points relate to a size of the display image. An indication line is generated according to the position of a selected identification point and the position of the original point. A correcting graphic content on the display image is displayed, where the correcting graphic content includes the identification points, the original point and the indication line. A control signal is received, where the control signal indicates a movement of the selected identification point. The position of the selected identification point and the indication line according to the control signal are modified, to modify the size of the display image.

Based on the above, in the embodiments of the present disclosure, the original point, the identification points, and the indication line connected between the original point and the selected identification point are showed on the display image projected by the projection module. The position of the selected identification point is moved according to the control signal, and the display image corresponding the selected identification point would be warped. Accordingly, it is easy to identify the boundary of the display image and the selected identification point, to help modify the size of the display image on a screen or stitch multiple display images for users.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a block diagram of components of a projection apparatus in accordance with an embodiment of the present disclosure.

FIG. 2 is a flow chart of a correcting method of a display image in accordance with an embodiment of the present disclosure.

FIGS. 3A-3C are schematic diagrams of warping the display image in accordance with an embodiment of the present disclosure.

FIGS. 4A-4C are schematic diagrams of warping the display image in accordance with another embodiment of the present disclosure.

### DESCRIPTION OF THE EMBODIMENTS

It is to be understood that other embodiment may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

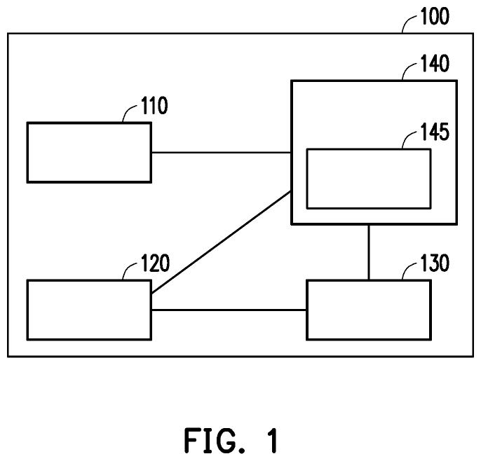

FIG. 1 is a block diagram of components of a projection apparatus 100 in accordance with an embodiment of the present disclosure. Referring to FIG. 1, the projection apparatus 100 includes, at least but not limited to, an input device 110, a memory 120, a projection module 130 and a processor 140. The projection apparatus 100 is used to project an image light to form videos, images, documents, or streaming media on a projection surface.

The input device 110 could be a circuit, a chip, or a transmission interface connected with buttons or a touch panel, which receives operation of a user (such as touch, press, move, etc.) directly, so as to receive a control signal corresponding to the operation of user from the buttons or the touch panel disposed on the case of the projection apparatus 100. Alternatively, the input device 110 could be a communication receiver supporting a communication protocol (such as Wi-Fi, infrared ray (IR), Bluetooth, etc.), to receive a control signal from an external controller (such as a remote controller, a computer, a smart phone, a tablet, etc.) wirelessly. The external controller may provide buttons or a touch panel to receive the operation of user. The control signal is used for controlling functions of the projection apparatus 100, and detailed contents are explained in the following embodiments.

The memory 120 could be a fixed or movable random access memory (RAM) in any types, a read-only memory (ROM), a flash memory or a memory of a combination of similar elements or the foregoing elements. The memory 120 is used for storing buffered or permanent data, software modules, display images, correcting graphic content, warping configurations, contents of on-screen display (OSD) menu and the like, and detailed contents are explained in the following embodiments.

The projection module 130 includes, at least but not limited to, lens, a light source (Laser diode, Light emitting diode or Lamp etc.), a control circuit and a light valve needed for a liquid crystal display (LCD), a digital micro-mirror device (DMD), an ultra-short throw or other projecting technologies (such as color filter, etc.). The projection module 130 is coupled to the memory 120, and displays/projects the display image (i.e., a projected image) and/or contents of OSD menu stored in the memory 120.

The processor 140 could be a central processing unit (CPU), a microcontroller, chip programmable controller, application-specific integrated circuit (ASIC), field programmable gate array (FPGA) or other similar components, or combinations of the above components. The processor 140 is coupled to the input device 110, the memory 120 and the projection module 130. In the embodiments of the present disclosure, the processor 140 controls the operation of the projection apparatus 100. For example, the processor 140 controls the projection module 130 to display a display image. In should be noticed that, in one embodiment, the processor 140 may further include an OSD processor 145, and the OSD processor 145 generates the contents displayed on the OSD menu (such as characters, patterns, color, line, etc.).

In order to facilitate the understanding of the operation flow of the embodiment of the present disclosure, the operation procedure of the projection apparatus 100 in the embodiments of the present disclosure will be described in detail below. Hereinafter, the method described in the embodiments of the present disclosure will be described in conjunction with various components and modules in the projection apparatus 100. The various processes of the method may be adjusted according to the implementation situation, and are not limited thereto.

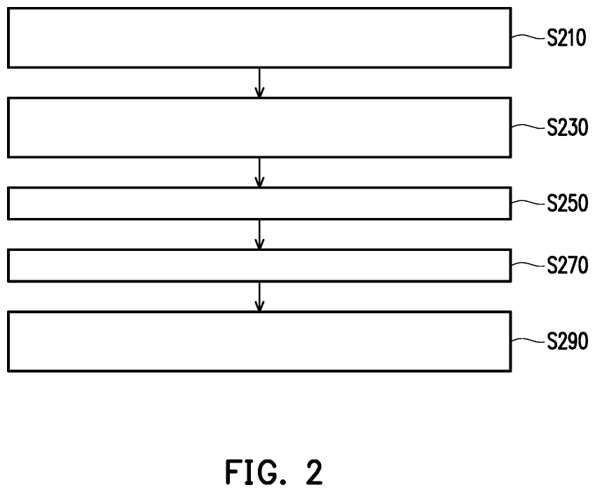

FIG. 2 is a flow chart of a correcting method of a display image in accordance with an embodiment of the present disclosure. Referring to FIG. 1 and FIG. 2, the processor 140 determines positions of one or more identification points and a position of an original point (Step S210). Specifically, the identification points are identification objects used for the warp function of the projection apparatus 100. The pattern of the identification points could be circle, square or other shapes with any color and/or any transparency. The boundaries of the display image relate to the size of the display image, and thus the positions of the identification points may be determined according to one or more boundaries of the display image. For example, the processor 140 may determine that the positions of the identification points are on four boundaries of the display image. The processor 140 may determine that the positions of the identification points are on four vertexes of the display image. Alternatively, the processor 140 may determine the position of the identification point according to a grid formed by multiple horizontal and vertical lines. The position of the identification point could be at one or more intersection points of the grid (i.e. the intersections of the horizontal and vertical lines). It should be noticed that, a spacing between two neighboring identification points could be same with the other two neighboring identification points or different from the other two neighboring identification points. In addition, the position of the identification points recorded in the memory 120 could be a coordinate or a relative position corresponding to a default point.

These identification points may include a selected identification (selected identification point) and one or more unselected identifications (unselected identification points). The selected identification can be moved, but the unselected identifications would be maintained at the current positions. In addition, in response to a movement of the selected identification, the display image could be warped accordingly, and the size of the display image can be modified. For example, if the positions of the identification points are determined on the four boundaries of the display image, the corresponding boundary and content of the display image would be warped according to the shape formed by connecting all identification points. In addition, the selected identification and unselected identifications on the display image could be displayed with different visual contents. For example, the visual contents for the selected and unselected identifications could be different colors, shapes, patterns, transparencies or sizes. Therefore, it is easy to identify the selected identification and unselected identifications.

In order to help user to identify the position of the selected identification, the present disclosure further provides the original point. The original point could be a reference point, which would be fixed at a position on the display image in response to the movement of the selected identification. The position of the original point could be located at any position on the display image. For example, the position of the original point could be determined at the center of the display image. It should be noticed that, if the position of the original point is determined around the center of the display image, the chance of showing the original point on a project target (such as a projection screen, a white board, a wall, or other desired object) at first may be increased.

Then, the processor 140 may generate an indication line according to the position of the identification point and the position of the original point (Step S230). Specifically, the indication line relates to a connection between the original point and the selected identification of the identification points. For example, the indication line could be a line, an arrow or other patterns. The indication line indicates that the positions of two ends thereof relate to the positions of the selected identification and the original point, respectively. For example, the indication line could be a straight line connected between the selected identification and the original point. Alternatively, the indication line could be an arrow from the original point with a line segment having a certain length, but the other end (i.e., a triangle segment) of the arrow may not reach the selected identification. The position of the original point, the positions of the indication points may be related to the coordinates on the display image.

Then, the processor 140 may display a correcting graphic content on the display image (Step S250). Specifically, the correcting graphic content includes the identification points, the original point and the indication line. In one embodiment, the OSD processor 145 may generate a first graphic layer including the correcting graphic content, and the processor 140 generates a second graphic layer including the display image. These two graphic layers would be stored in the memory 120. Then, the processor 140 may control the projection module 130 to display the first and second graphic layers, so that the correcting graphic content would be overlapped on the display image. It should be noticed that, in some embodiments, the processor 140 may display the second graphic layer with higher transparency or merely display the first graphic layer by the projection module 130 in a warp procedure of the display image.

In another embodiment, the processor 140 may combine the display image with the correcting graphic content and generate a new display image including the original display image and the correcting graphic content. For example, some portions of the display image overlapped with the identification points, the original point and the indication line would be replaced by the corresponding correcting graphic content. Then, the processor 140 may display the new display image by the projection module 130. Accordingly, it may help user figure out the position of the selected identification according to the indication line.

Regarding a modification of the size of the display image, it may be initiated in response to a triggering procedure. The triggering procedure may be that the processor 140 receives a control signal from the input device 110 (Step S270). In one of the embodiment, the control signal may indicate a movement of the selected identification. It is assumed that an external controller or button/touch panel of the projection apparatus 100 receives operation of user corresponding to changing the position of the selected identification. The movement of the selected identification could be move a default stride (for example, 5, 10, or 20 pixels of the display image) toward a designated direction (for example, upward, downward, leftward, and rightward, etc.).

Then, the processor 140 may modify the position of the selected identification and the indication line according to the control signal (Step S290), to modify the size of the display image. Specifically, the position of the selected identification would be modified according to an indication of the movement of the selected identification from the control signal. For example, the control signal indicates that the selected identification moves 10 pixels downwardly. Finally, depending on the modify the size of the display image, the boundary of the display image is substantially equal to the boundary of the white board. On the other hand, as introduced in step S230, one end of the indication line relates to the position of the selected identification. The indication line would be modified according to the movement of the selected identification, so that the connection between the original point and the selected identification would be maintained. In addition, the processor 140 warps the display image according to the modified position of the selected identification, so that the size of the display image would be modified accordingly.

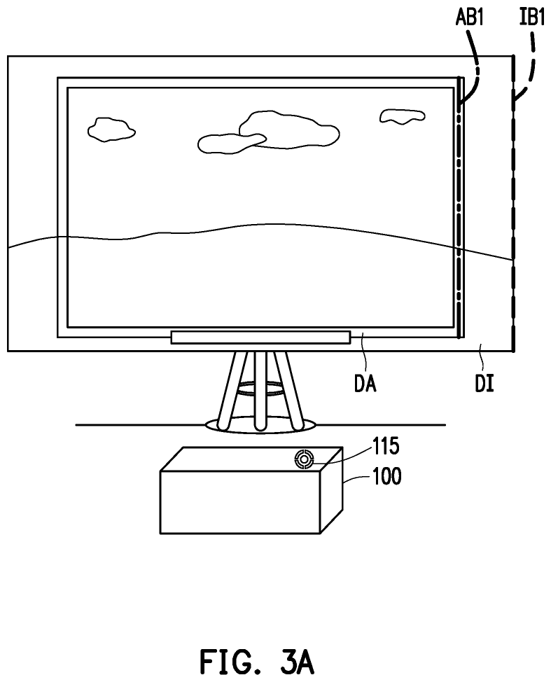

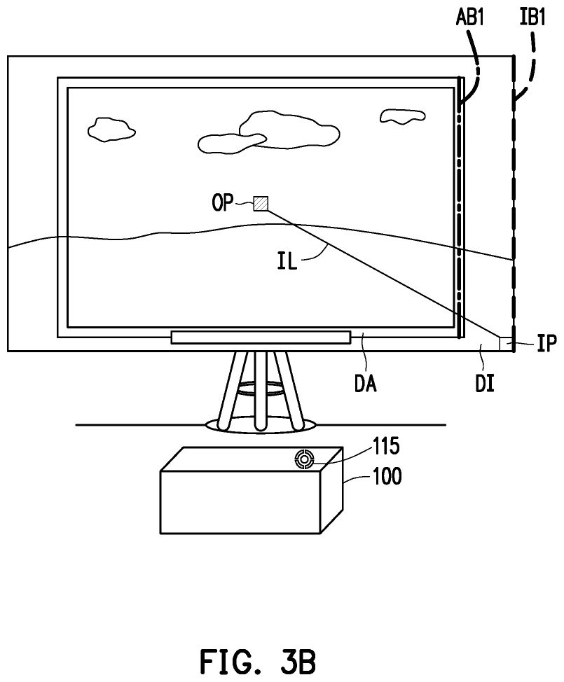

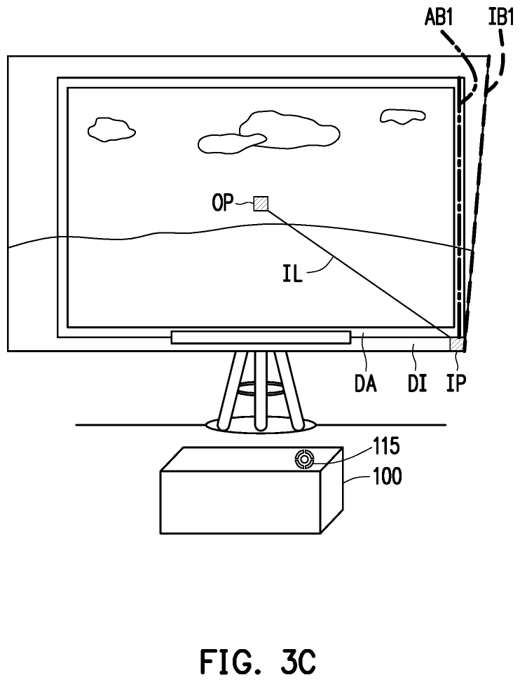

In order to make the spirit of the disclosure more comprehensible, two embodiments would be provided below. FIGS. 3A-3C are schematic diagrams of warping the display image in accordance with an embodiment of the present disclosure. Referring to FIG. 3A first, the projection apparatus 100 is equipped with buttons 115. The buttons 115 comprises upward, downward, leftward, right and confirm, respectively. A display image DI is larger than a white board DA after the projection apparatus 100 is placed on the position to project an image light to the white board DA as shown in FIG. 3A. A boundary IB1 of the display image DI is located outside of a boundary AB1 of the white board DA.

Referring to FIG. 3B, after the projection apparatus 100 enters a geometric correction mode by the operation of the user, an original point OP, an identification point IP and an indication line IL are displayed on the display image DI. The original point OP is located at the center of the display image DI. The indication line IL directly connects to the original point OP and the identification point IP. Even though the indication point IP may not be identified easily by eye of the user, the indication line IL would help user to know the position of the identification point IP.

Referring to FIG. 3C, a button 115 of “leftward” is pressed. The projection apparatus 100 would receive a control signal indicating a leftward movement of the identification point IP (which is a selected identification in this embodiment). The position of the identification point IP is modified as shown in FIG. 3C. The three unselected identifications are located the other three vertexes of the display image DI with 100% transparency in this embodiment. The display image DI is warped, where the boundary IB1 is tilted along with identification point IP. The modification of the indication line IL would help user to know how many displacement of the identification point IP.

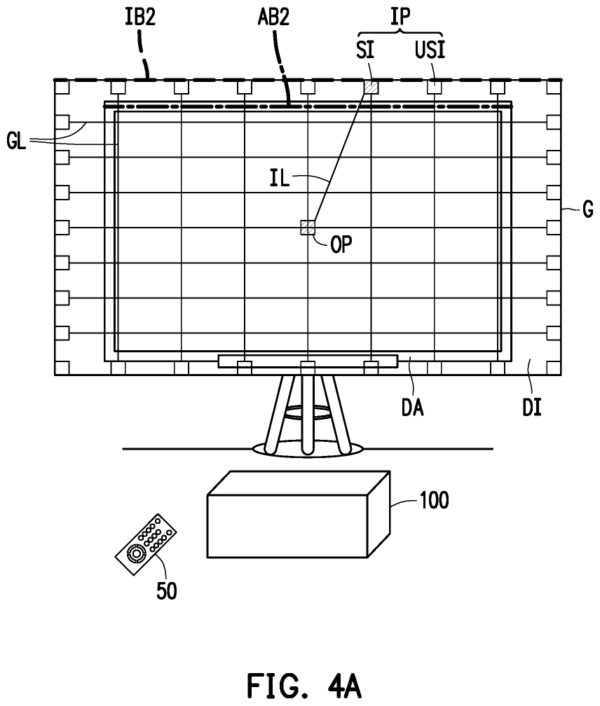

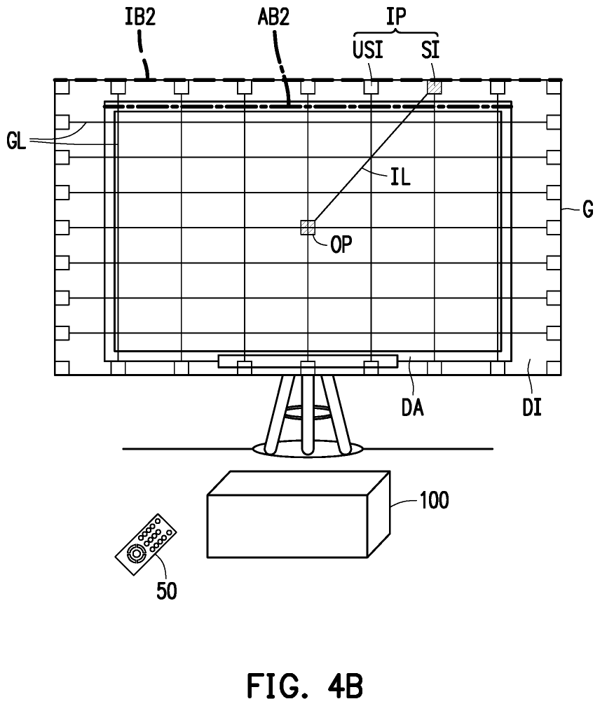

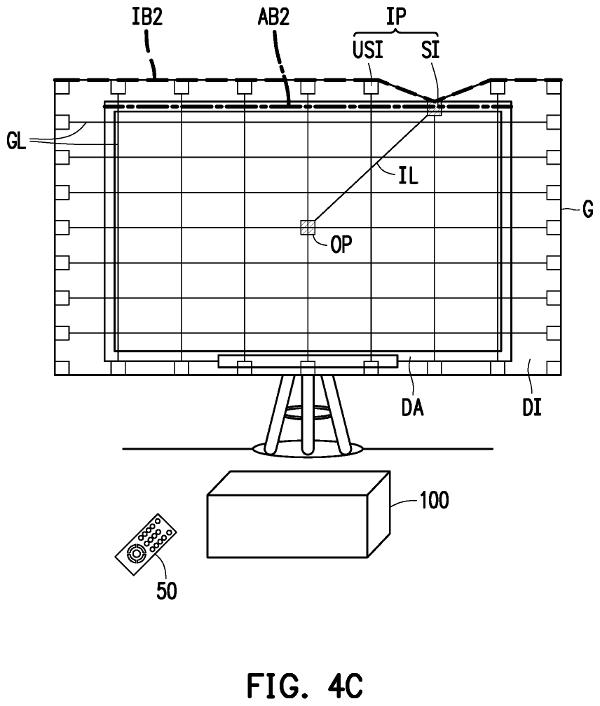

FIGS. 4A-4C are schematic diagrams of warping the display image in accordance with another embodiment of the present disclosure. Referring to FIG. 4A first, difference between the embodiments of FIGS. 3B-3C and FIG. 4A are following features. A remote controller 50 controls operations of the projection apparatus 100. A boundary IB2 of the display image DI is located outside of a boundary AB2 of the white board DA. The correcting graphic content further includes a grid G. The 9×9 grid G is merely an example, the grid number could be modified according to a control signal in response to the operation of user or another default configuration. In addition to, the projection apparatus 100 enters a grid correction mode by the operation of the user after the geometric correction mode. The grid number may be selected. For example, 2×2, 3×3, 5×5, 17×17. The identification points IP are located on intersection points of grid lines GL of the grid G and four boundaries of the display image DI. The color of the selected identification SI is different from the color of the unselected identification USI (transparency is less than 100%). In addition, the color of the identification line IL is different from the color of grid lines GL. The correcting graphic content may include a background with a specific color to cover the display image DI, to help user to identify the correcting graphic content.

Referring FIGS. 4A and 4B, the projection apparatus 100 receives a control signal indicating a selection of the selected identification SI. The processor 140 would change the selected identification SI shown in FIG. 4A as one unselected identification USI shown in FIG. 4B, and change another one unselected identification USI shown in FIG. 4A as the selected identification SI shown in FIG. 4B according to the selection of the selected identification SI. The indication line IL would be modified to connect to the selected identification SI shown in FIG. 4B.

Referring to FIG. 4C, the projection apparatus 100 may receive a control signal to indicate moving the identification points downward. The position of the selected identification SI is modified as shown in FIG. 4C. The display image DI is warped along with a warped shape formed by connecting all identification points IP. The positions of boundary points corresponding to the unselected identifications USI on the boundary IB2 of the display image DI are maintained.

In summary, the projection apparatus and the correcting method of the embodiment of the present disclosure provide an indication line connected an original point and a selected identification on a display image, to help user to identify the position of the selected identification. The indication line would be modified according to a movement of the selected identification, so that user can figure out a displacement of the selected identification. Even the display image is larger than a projection screen or identification points are covered by other objects, the embodiment of the present disclosure would provide an indication function for the selected identification. Accordingly, the embodiment of the present disclosure would help user to modify the size of the display image or stitch multiple display images. In addition, a grid or different visual contents would further improve the efficiency of the warp procedure by users.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

1. A projection apparatus, comprising:
an input device, adapted to receive a control signal;
a memory, adapted to store a correcting graphic content, wherein the correcting graphic content comprises identification points, an original point and an indication line, and the indication line relates to a connection between the original point and a selected identification point of the identification points;
a projection module, coupled to the memory, and adapted to display the correcting graphic content on a display image when the projection apparatus enters into a geometric correction mode in which a boundary of the display image is located outside a boundary of a projection target; and
a processor, coupled to the input device, the memory and the projection module, and adapted to control the projection module to display the display image.

2. The projection apparatus of claim 1, wherein the processor is configured to:
determine positions of the identification points and a position of the original point, wherein the positions of the identification points relate to a size of the display image;
generate the indication line according to a position of the selected identification point and the position of the original point; and
modify the position of the selected identification point and the indication line according to the control signal, to modify the size of the display image displayed by the projection module, wherein the control signal indicates a movement of the selected identification point.

3. The projection apparatus of claim 1, wherein the processor is configured to:
determine the positions of the identification points according to the boundary of the display image, wherein the boundary of the display image relates to the size of the display image; and
control the projection module to warp the display image according to the movement of the selected identification point.

4. The projection apparatus of claim 3, wherein the processor is configured to:
determine that the positions of the identification points are on the boundary of the display image.

5. The projection apparatus of claim 3, wherein the identification points further comprise a plurality of unselected identification points, and the processor is configured to:
control the projection module to maintain positions of boundary points on the boundary of the display image, wherein the boundary points correspond to the unselected identification points.

6. The projection apparatus of claim 5, wherein the processor is configured to:
display the selected identification point and unselected identification points on the display image with different visual contents by the projection module.

7. The projection apparatus of claim 2, wherein the control signal indicates a grid, and the processor is configured to:
determine the position of the identification point according to the grid, wherein the position of the identification point is determined on at least one intersection point of the grid.

8. The projection apparatus of claim 7, wherein the grid is comprised in the correcting graphic content.

9. The projection apparatus of claim 2, wherein the control signal indicates a selection of the selected identification point, the identification points further comprise unselected identification points, and the processor is configured to:
change the selected identification point as one of the unselected identification points; and
change another one of the unselected identification points as the selected identification point according to the selection of the selected identification point.

10. The projection apparatus of claim 2, wherein the processor is configured to:
determine that the position of the original point is at a center of the display image; and
determine the indication line as a line connected between the original point and the selected identification point.

11. The projection apparatus of claim 2, wherein the processor comprises an on-screen display (OSD) processor, and the processor is configured to:
generate a first graphic layer comprising the correcting graphic content by the OSD processor;
generate a second graphic layer comprising the display image; and
control the projection module to display the first and second graphic layers.

12. The projection apparatus of claim 2, wherein the control signal is generated by an external controller.

13. A correcting method of a display image, adapted for a projection apparatus displaying the display image, the correcting method comprising:
determining positions of identification points and a position of an original point, wherein the positions of the identification points relate to a size of the display image;
generating an indication line according to a position of a selected identification point and the position of the original point, wherein the indication line relates to a connection between the original point and a selected identification point of the identification point;
displaying a correcting graphic content on the display image when the projection apparatus enters into a geometric correction mode in which a boundary of the display image is located outside a boundary of a projection target, wherein the correcting graphic content comprises the identification points, the original point and the indication line;
receiving a control signal, wherein the control signal indicates a movement of the selected identification point; and
modifying the position of the selected identification point and the indication line according to the control signal, to modify the size of the display image.

14. The correcting method of claim 13, wherein the step of determining the positions of the identification points and the position of the original point comprises:
determining the positions of the identification points according to the boundary of the display image, wherein the boundary of the display image relates to the size of the display image; and the step of modifying the position of the selected identification point and the indication line according to the control signal comprises:
warping the display image according to the movement of the selected identification point.

15. The correcting method of claim 14, wherein the step of determining the positions of the identification points according to the boundary of the display image comprises:
determining that the positions of the identification points are on the boundary of the display image.

16. The correcting method of claim 14, wherein the identification points further comprise a plurality of unselected identification points and the step of displaying the correcting graphic content on the display image comprises:
maintaining positions of boundary points on the boundary of the display image, wherein the boundary points correspond to the unselected identification points.

17. The correcting method of claim 16, wherein the step of displaying the correcting graphic content on the display image comprises:
displaying the selected identification point and unselected identification points on the display image with different visual contents.

18. The correcting method of claim 13, wherein the control signal indicates a grid, and the step of determining the positions of the identification points and the position of the original point comprises:
determining the position of the identification point according to the grid, wherein the position of the identification point is determined on at least one intersection point of the grid.

19. The correcting method of claim 18, wherein the grid is comprised in the correcting graphic content.

20. The correcting method of claim 13, wherein the control signal indicates a selection of the selected identification point, the identification points further comprise unselected identification points, and the step of determining the positions of the identification points and the position of the original point comprises:
changing the selected identification point as one of the unselected identification points; and
change another one of the unselected identification points as the selected identification point according to the selection of the selected identification point.

21. The correcting method of claim 13, wherein the step of determining the positions of the identification points and the position of the original point comprises:
determining the position of the original point at a center of the display image; and the step of generating the indication line according to the positions of the identification points and the position of the original point comprises:
determining the indication line as a line connected between the original point and the selected identification point.

22. The correcting method of claim 13, wherein the step of displaying the correcting graphic content on the display image comprises:
generating a first graphic layer comprising the correcting graphic content by an on-screen display (OSD) processor;
generating a second graphic layer comprising the display image; and
displaying the first and second graphic layers.

23. The correcting method of claim 13, wherein the control signal is generated by an external controller.
